(19) United States
(12) Patent Application Publication
(10) Pub. No.: US 2016/0040551 A1
(43) Pub. Date: Feb. 11, 2016

(54) GEOMETRICALLY SEGMENTED COATING ON CONTOURED SURFACES

(71) Applicant: UNITED TECHNOLOGIES CORPORATION, Hartford, CT (US)

(72) Inventors: Christopher W. Strock, Kennebunk, ME (US); Joel H. Wagner, Wethersfield, CT (US); Paul M. Lutjen, Kennebunkport, ME (US)

(21) Appl. No.: 14/813,294

(22) Filed: Jul. 30, 2015

Related U.S. Application Data
(60) Provisional application No. 62/033,739, filed on Aug. 6, 2014.

(51) Int. Cl. F01D 25/00; F01D 5/28; C23C 28/00

(52) U.S. Cl. CPC F01D 25/005; C23C 28/30; F01D 25/007; F01D 5/288; F05D 2220/32; F05D 2230/31; F05D 2300/10; F05D 2300/702

(57) ABSTRACT

A method of locating a surface feature for a geometrically segmented coating on a contoured surface comprising providing an article having a contoured surface; overlaying an assembly of ligaments on the contoured surface; and locating a surface feature at a predetermined location relative to each ligament.

### CROSS REFERENCE TO RELATED APPLICATION

This application claims the benefit of provisional application Ser. No. 62/033,739, filed Aug. 6, 2014.

### BACKGROUND

The present disclosure is directed to a method for designing the surface geometry associated with geometrically segmented abradable ceramic (GSAC) thermal barrier coating (TBC) on parts with complex shape.

Components that are exposed to high temperatures, such as a component within a gas turbine engine, typically include protective coatings. For example, components such as turbine blades, turbine vanes, blade outer air seals, and compressor components typically include one or more coating layers that function to protect the component from erosion, oxidation, corrosion or the like to thereby enhance component durability and maintain efficient operation of the engine.

As an example, some conventional turbine blade outer air seals include an abradable ceramic coating that contacts tips of the turbine blades such that the blades abrade the coating upon operation of the engine. The abrasion between the outer air seal and the blade tips provide a minimum clearance between these components such that gas flow around the tips of the blades is reduced to thereby maintain engine efficiency. Over time, internal stresses can develop in the protective coating to make the coating vulnerable to erosion and spalling. The outer air seal may then need to be replaced or refurbished after a period of use.

Increasing emphasis on environmental issues and fuel economy continue to drive turbine temperatures up. The higher engine operating temperatures results in an ever increasing severity of the operating environment inside a gas turbine. The severe operating environment results in more coating and base metal distress and increased maintenance costs. For example, more frequent replacement of the outer air seals.

A coating exists called a geometrically segmented abradable ceramic, (GSAC). The GSAC in development has the potential to satisfy the above described needs in many applications, however the current manufacturing methods are very costly with many added manufacturing steps including metallic layer buildup, diffusion heat treat and CNC milling of the divot structure. The complex surface geometry of certain parts and components creates a challenge to obtaining the best possible placement of surface features associated with the GSAC. There exists a need for a more effective process to locate the surface features of a GSAC on complex surface shapes.

### SUMMARY

In accordance with the present disclosure, there is provided a method of locating a surface feature for a geometrically segmented coating on a contoured surface comprising providing an article having a contoured surface; overlaying an assembly of ligaments on the contoured surface; and locating a surface feature at a predetermined location relative to each ligament.

In another embodiment, a method of locating a surface feature for a geometrically segmented coating on a contoured surface comprises providing an article having a contoured surface. The method including overlaying a triangular assembly of ligaments on the contoured surface and locating a surface feature at the center of each ligament.

In another embodiment, the method further comprises varying the size of the surface feature. The surface feature includes sharp corners and rounded corners. The article is a gas turbine engine component. The article is a gas turbine engine seal member.

In another embodiment, the assembly of ligaments is selected from the group consisting of a triangular assembly, a hexagonal assembly and a polygonal assembly.

In another embodiment, the predetermined location on each ligament is selected from the group consisting of a center of the ligament, and end of the ligament and a junction of ligaments.

In another alternative embodiment, a method of locating a surface feature for a geometrically segmented coating on a gas turbine engine component having contoured surfaces comprises providing the gas turbine engine component having at least one contoured surface; overlaying an assembly of ligaments on the contoured surface; locating a surface feature at a predetermined location relative to a portion of each said ligament; forming the surface feature in the contoured surface at the location; disposing a thermally insulating topcoat over the surface feature; and forming segmented portions that are separated by faults extending through the thermally insulating topcoat from the surface feature.

In another embodiment, the method further comprises forming a pattern of features on the at least one contoured surface.

In another embodiment, the triangular assembly of ligaments conforms to the contoured surface. The surface feature comprises at least one of a sharp edge and a round edge. The surface feature comprises a sharp edge proximate a top and a bottom of the surface feature.

In another embodiment, the method further comprises disposing a bond coat layer to the at least one contoured surface, before disposing the thermally insulating topcoat.

In another embodiment, the gas turbine engine component is at least one of an airfoil, a seal, a bulkhead, a fuel nozzle guide, a transition duct and a combustor casing.

In another embodiment a method of locating a surface feature for geometrically segmented coatings on a gas turbine engine component having contoured surfaces comprises providing the gas turbine engine component having at least one contoured surface; overlaying an assembly of ligaments on the contoured surface; identifying a location for a surface feature on at least one of a geometric center of the assembly of ligaments and an intersection of the assembly of ligaments, a center of the ligaments, an end of the ligaments, and a combination of center and end of the ligaments; forming the surface feature in the contoured surface at the location; disposing a thermally insulating topcoat over the surface feature; and forming segmented portions that are separated by faults extending through the thermally insulating topcoat from the surface feature.

In another embodiment the surface feature comprises at least one of a triangular shape, a circular shape, a hexagonal shape and a polygonal shape.

In another embodiment, the method further comprises forming the shaped surface feature from at least one of milling, laser engraving, casting, chemical etching and additive manufacturing.

In another embodiment, the method further comprises disposing a bond coat layer to the at least one contoured surface, before disposing the thermally insulating topcoat.

In another embodiment, the gas turbine engine component is at least one of an airfoil, a seal, a bulkhead, a fuel nozzle guide, a transition duct and a combustor casing.

In another embodiment, the assembly of ligaments is selected from the group consisting of a triangular assembly, a hexagonal assembly and a polygonal assembly.

Other details of the method are set forth in the following detailed description and the accompanying drawing wherein like reference numerals depict like elements.

### BRIEF DESCRIPTION OF THE DRAWINGS

FIG. 1 is a schematic representation of an exemplary turbine engine.

FIG. 2 is a turbine section of the turbine engine.

FIG. 3 is an exemplary portion of a turbine article.

FIG. 4 is an exemplary a geodesic dome whose sub structure is a triangular assembly of straight ligaments with an exemplary triangular assembly.

FIG. 5 is an exemplary gas turbine engine component having contoured surfaces with an exemplary triangular assembly.

FIG. 6 is an exemplary article with a complex curvature having contoured surfaces with an exemplary assembly.

FIG. 7 is the process steps map of the inventive method.

### DETAILED DESCRIPTION

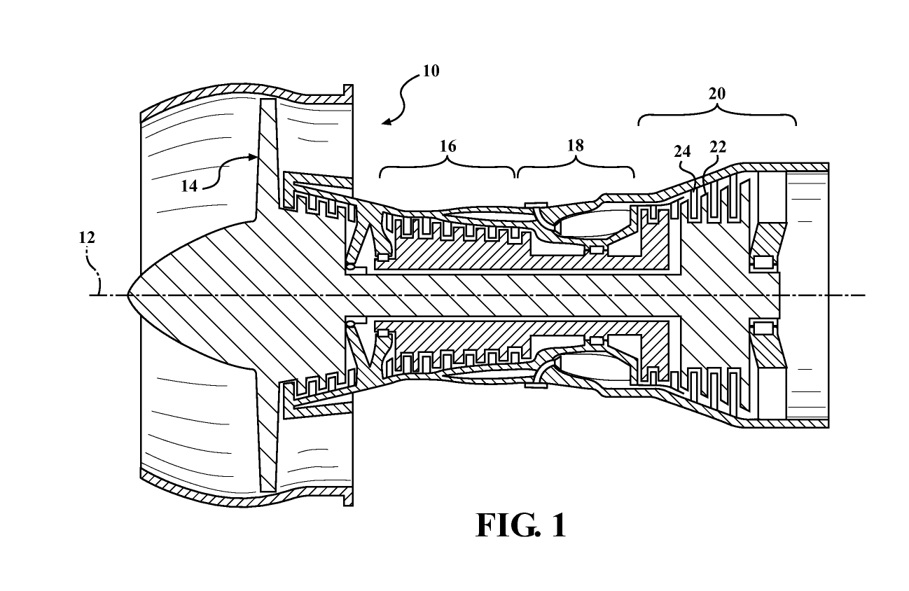

Referring now to the FIG. 1 illustrates selected portions of an exemplary gas turbine engine 10, such as a gas turbine engine 10 used for propulsion. In this example, the gas turbine engine 10 is circumferentially disposed about an engine centerline 12. The engine 10 may include a fan 14, a compressor 16, a combustion section 18, and a turbine section 20 that includes rotating turbine blades 22 and static turbine vanes 24. It is to be understood that other types of engines may also benefit from the examples disclosed herein, such as engines that do not include a fan or engines having other types of compressors, combustors, and turbines.

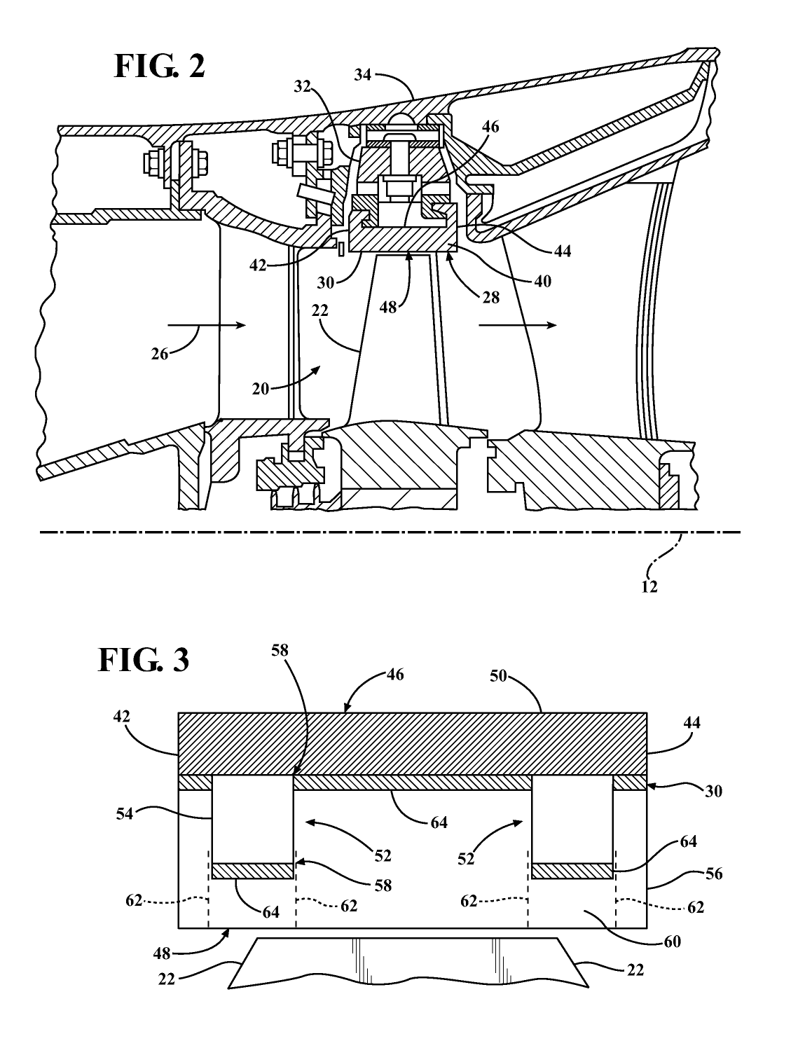

FIG. 2 illustrates selected portions of the turbine section 20. The turbine blades 22 receive a hot gas flow 26 from the combustion section 18 (FIG. 1). The turbine section 20 includes a blade outer air seal system 28, having a plurality of seal members 30, or gas turbine articles, that function as an outer wall for the hot gas flow 26 through the turbine section 20. Each seal member 30 is secured to a support 32, which is in turn secured to a case 34 that generally surrounds the turbine section 20. For example, a plurality of the seal members 30 may be arranged circumferentially about the turbine section 20. It is to be understood that the seal member 30 is only one example of an article in the gas turbine engine and that there may be other articles within the gas turbine engine that may benefit from the examples disclosed herein.

FIG. 3. illustrates a portion of seal member 30 having two circumferential sides 40 (one shown), a leading edge 42, a trailing edge 44, a radially outer side 46, and a radially inner side 48 that is adjacent to the hot gas flow path 26. It should be noted that the view in FIG. 3 is a small section of a part cross section. Leading edge 42 and trailing edge 44 do not necessarily have to be leading and trailing edges of the part, but rather the forward and aft edges of the section shown. In an exemplary embodiment, they can represent actual leading and trailing edges. The term “radially” as used in this disclosure relates to the orientation of a particular side with reference to the engine centerline 12 of the gas turbine engine 10.

The seal member 30 includes a substrate 50, a plurality of divots, or geometric features or surface geometry 52 (hereinafter “features”) that are formed in a surface 54 on the gas path side of the seal member 30, and a thermally insulating topcoat 56 (e.g., a thermal barrier or TBC) disposed over the plurality of features 52 formed in the surface 54. The features 52 may not be shown to scale. The substrate 50 may include attachment features (not shown) for mounting the seal member 30 within the gas turbine engine 10.

The thermally insulating topcoat 56 includes segmented portions 60 that are separated by faults 62 extending through the thickness of the thermally insulating topcoat 56 from the features 52. The faults 62 extend from the edges or sides of the features 52 and facilitate reducing internal stresses within the thermally insulating topcoat 56 that may occur from sintering of the topcoat material at relatively high temperatures within the turbine section 20 during use in the gas turbine engine 10. Depending on the composition of the topcoat 56, surface temperatures of about 2500 degrees Fahrenheit (1370 degrees C.) and higher may cause sintering. The sintering may result in densification and diffusional shrinkage of the thermally insulating topcoat 56 and thereby induce internal stresses. In conventional non-segmented coatings the internal stresses due to sintering shrinkage may be high enough to cause spallation of the coating. In GSAC coating, the faults 62 provide pre-existing locations for accommodating the strain associated with sintering, reducing the internal stresses (e.g., reducing shear and radial stresses). That is, the energy associated with the internal stresses is maintained at a lower level due to the faults 62 such that there is less energy available for causing delamination cracking between the thermally insulating topcoat 56 and the underlying surface 54, substrate 50 or a bond coat 64 and spallation. The faults 62 facilitate reduction of internal stress energy within the thermally insulating topcoat 56.

The faults 62 may be produced by using any of a variety of different geometric surface features formed in the surface 54. In an exemplary embodiment, the surface features can comprise at least one of a triangular shape, a circular shape, a hexagonal shape, and any other polygonal shape. The triangular shape can include pointed or sharp ends and/or rounded ends/corners. In some manufacturing processes, such as, end mill or etching processes the corners can be rounded. The pattern and shape of the features 52 is not limited to any particular pattern and may be a grid type of pattern with individual perforations that extend from one surface of the sheet to the other surface of the surface 54. For example, a hexagonal close packed pattern of perforations may be formed in a sheet. Other patterns can include triangle, and polygonal patterns. The perforations being 0.080 inches in diameter and spaced on center at 0.105inch spacing.

The feature 52 forming process is selected to produce edges or sharp corners 58. Sharp corners at both the top and bottom of the GSAC divots are necessary for producing the necessary coating segmentation structure 60, 62. In an exemplary embodiment, the sharp corners 58 can be defined by the sum of the two radii less than or equal to 50 percent of the feature 53 height/depth. In another exemplary embodiment, the process can form sharp corners and/or rounded corners to any degree or combination as necessary to produce the coating segmentation structure 60.

The geometric surface features 52 may be selected to be any of a variety of different patterns or shapes. As an example, the features 52 may be formed as hexagonal walls that define a cell structure therebetween. Alternatively, the walls may be other shapes and need not be continuous.

The material selected for the substrate 50, bond coat 64 (if used), and thermally insulating topcoat 56 are not necessarily limited to any particular kind. For application on the seal member 30, the substrate 50 may be a metal alloy, such as a nickel based alloy.

The bond coat 64 may include any suitable type of bonding material for attaching the thermally insulating topcoat 56 to the surface 54. In some embodiments, the bond coat 64 includes a nickel alloy, platinum, gold, silver, or MCrAlY where the M includes at least one of nickel, cobalt, iron, or combination thereof, Cr is chromium, Al is aluminum and Y is yttrium. The bond coat 64 may be approximately 0.005 inches thick (approximately 0.127 millimeters), but may be thicker or thinner depending, for example, on the type of material selected and requirements of a particular application.

The thermally insulating topcoat 56 may be any type of ceramic material suited for providing a desired heat resistance in the gas turbine article. As an example, the thermally insulating topcoat 56 may be an abradable coating, such as yttria stabilized with zirconia, hafnia, and/or gadolinia, gadolinia zirconate, molybdate, alumina, or combinations thereof. The topcoats 56 may also include porosity. While various porosities may be selected, typical porosities in a seal application include 5 to 70% by volume.

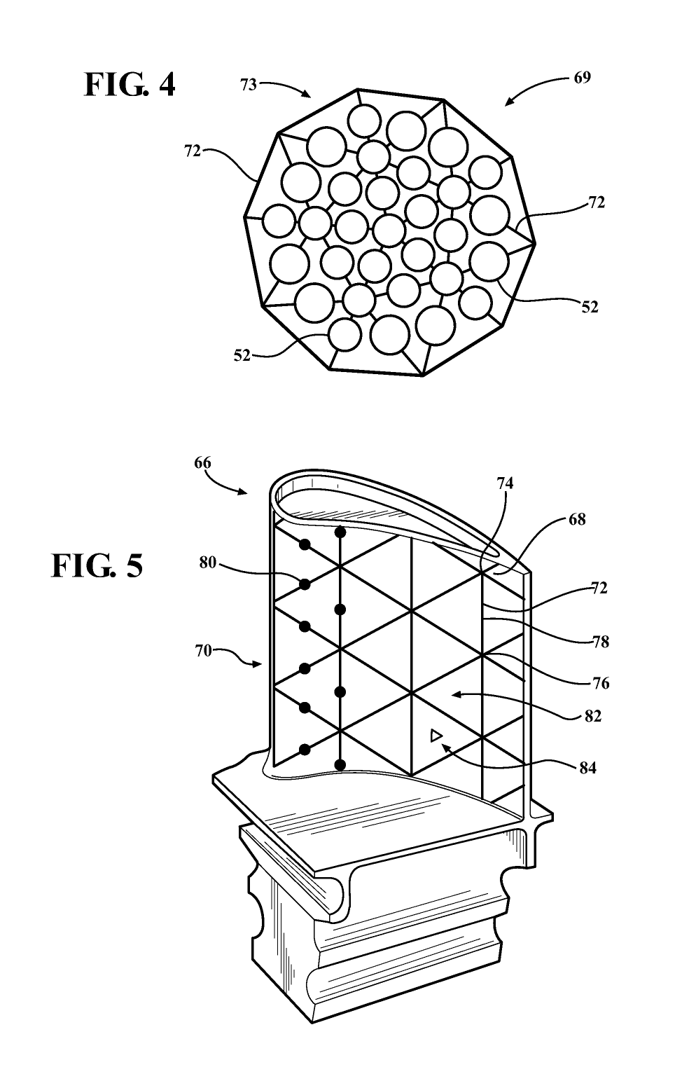

Location of the surface features 52 may be optimized by way of a method that can be explained via a simple example, envision the structure of a geodesic dome 69 whose sub structure is a triangular assembly 70 of straight ligaments 72. (See FIG. 4.) These ligaments 72 are not all the same length. They are slightly varied to collocate their intersections with the surface of a sphere 73 and create smooth transition to added or removed triangles as they conform to the surface. Many mathematical methodologies exist for the optimization of a mesh to a contoured surface. The methodologies chosen for the present purpose strive to normalize triangle shape to equilateral and edge length to be as near as possible to equal. Features may be placed at the center, anywhere along the length of each ligament, even at the ends of each ligament. The ligament may have a constant diameter or a diameter varying in proportion to the ligament length and shape of adjacent triangles.

Varying feature diameter will help to maintain design criteria for the desired ratios of coating thickness to feature diameter, depth and inter-divot spacing.

FIG. 5 illustrates an exemplary diagram of a gas turbine engine component 66, such as a turbine blade having contoured surfaces 68 with a triangular assembly overlay 70. The features 52 can be located along the contoured surface 68 of the component 66. The triangular assembly 70 includes straight ligaments 72. The ligaments 72 include a length having first and second ends 74, 76 and a center 78. Features 52 can be located on the contoured surface 68 of the component 66 by utilizing the triangular assembly 70 as an overlay on the contoured surface 68. The features 52 can be located at locations 80 at the center 78 of the ligament 72. In an exemplary embodiment, the ligament 72 can be located at the center 78, at the ends 74, 76 or any subset thereof and therebetween. By locating the features 52 at the locations 80 a pattern 82 of features 52 can be formed on the contoured surface 68 at multiple locations.

In an alternative embodiment, the features can be located at locations in the center of the triangle formed by the intersection of the ligaments 72. The features 52 can be formed as triangle shaped features 84. This geometry would be best produced by casting, chemical etching or additive manufacturing. More complex shapes can of course be meshed and covered with features for formation of GSAC-TBC.

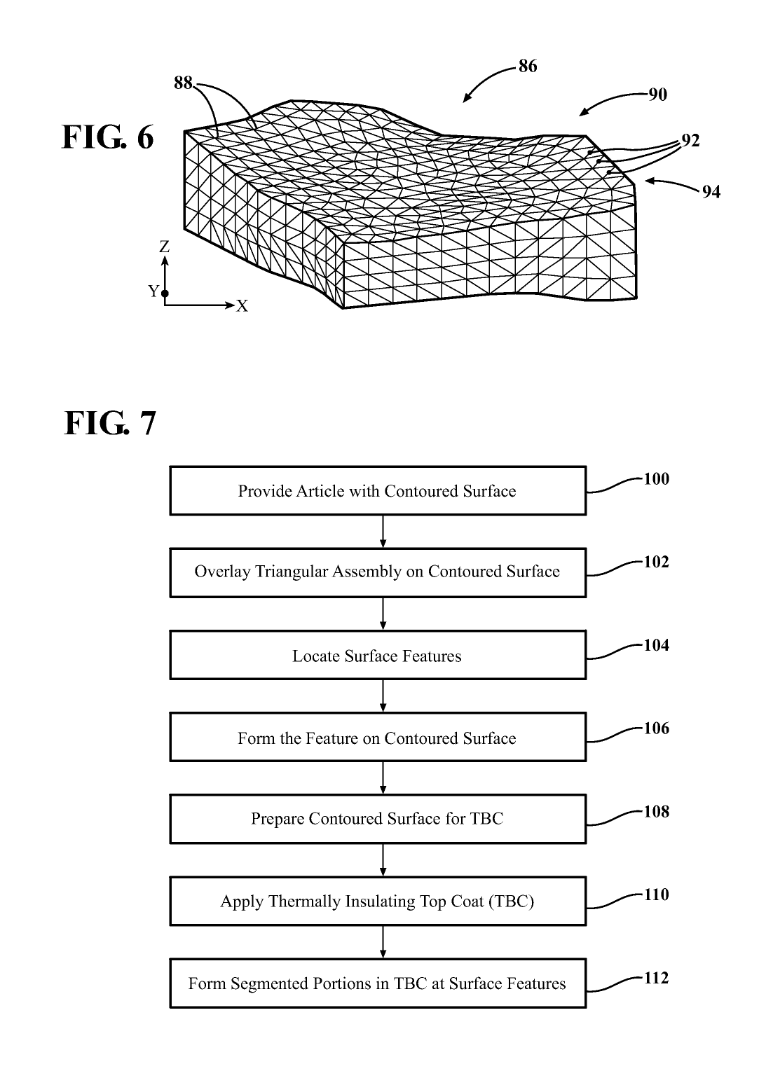

FIG. 6 illustrates an article with a complex curvature 86. The article 86 represents any component that may have contoured surfaces that requires the formation of GSAC. An assembly of ligaments 88 is shown to cover the contoured surface 90 of the article with a complex curvature 86. For this more complex three dimensional shape, the assembly of ligaments 88 utilizes more triangles with varying ligament lengths in order to conform with the complex curvature. It is contemplated that the assembly of ligaments 88 can be selected from a group consisting of a triangular assembly, a hexagonal assembly and a polygonal assembly. As with the article shown at FIG. 5, surface features 92 can be located at a predetermined location 94 on each ligament. The predetermined location 94 can include a center of the ligament, and end of the ligament and at a junction of any ligaments, and any subset thereof or therebetween. The surface feature 92 can comprise a triangular shape, a circular shape and a hexagonal shape.

FIG. 7 illustrates a diagram of the inventive process used to locate a surface feature for a geometrically segmented coating on a contoured surface. At step 100 an article having a contoured surface is provided. The article can be any article that would require the application of a geometrically segmented coating. The article can be components of a gas turbine engine, such as an airfoil, a blade, a vane, a seal, a casing for a combustor and the like. At step 102 the method includes overlaying a triangular assembly of ligaments on the contoured surface. The next step 104 is locating a surface feature on the triangular assembly. The location can be at the center of each ligament. In alternative embodiments, the location can be at the center of the triangle formed within the triangular assembly, or at the intersection of the ligaments. The step 106 includes forming at least one feature 52 on the contoured surface 68. The details of forming the feature 52 have been described above. At step 108 the contoured surface of the component is prepared for application of the thermally insulating top coat (TBC). Heat treating, grit blast and other preparations can be performed on the component. In an alternative embodiment, a bond coat can be applied before the thermally insulating top coat. In another alternative embodiment, the bond coat and assembly can be diffusion heat treated. After the contoured surface preparation, the thermally insulating top coat is applied at step 110. If desired the surfaces can have a surface finish process applied, such as grinding. At step 112 segmented portions that are separated by faults extending through the thermally insulating topcoat from the surface feature are formed for the geometrically segmented abradable ceramic, (GSAC).

There has been provided a method of producing an array of surface features (surface geometry) that are adapted to complex surfaces by using a meshing method similar to those used to mesh a surface in finite element modeling. The method provides for an economical manufacturing process for GSAC part geometry. This method would be very applicable to use on large and simple geometry industrial gas turbine parts. The inventive method is a technique utilized to map out the best fit for the placement of the surface features that form the GSAC instead of using Cartesian methods to locate the surface features.

The use of the triangle geometry in the location method allows for a best fit of the surface features for the irregular shapes found on components, such as, airfoils and other engine parts. While the method has been described in the context of specific embodiments thereof, other unforeseen alternatives, modifications, and variations may become apparent to those skilled in the art having read the foregoing description. The present invention provides the method and resultant product of geometrically segmented ceramic thermal barrier coating (GSC-TBC) on complex geometry.

The proven temperature/durability improvement achieved by this surface geometry method will now be available on complex shapes. This will improve the durability of air plasma sprayed TBC or permit operation at higher temperature or with lower cooling air flow rate. Accordingly, it is intended to embrace those alternatives, modifications, and variations which fall within the broad scope of the appended claims.

What is claimed is:

1. A method of locating a surface feature for a geometrically segmented coating on a contoured surface comprising:
providing an article having a contoured surface; overlaying an assembly of ligaments on said contoured surface; and
locating a surface feature at a predetermined location relative to each said ligament.

2. The method of claim 1 wherein said assembly of ligaments is selected from the group consisting of a triangular assembly, a hexagonal assembly and a polygonal assembly.

3. The method of claim 1 further comprising:
varying the size of said surface feature.

4. The method of claim 1 wherein said article is a gas turbine engine component.

5. The method of claim 1 wherein said predetermined location relative to each said ligament is selected from the group consisting of a center of said ligament, and end of said ligament, a combination of center and end of said ligament, and a geometric center of said assembly of ligaments.

6. A method of locating a surface feature for a geometrically segmented coating on a gas turbine engine component having contoured surfaces comprising:
providing said gas turbine engine component having at least one contoured surface;
overlaying an assembly of ligaments on said contoured surface;
locating a surface feature at a predetermined location relative to a portion of each said ligament;
forming said surface feature in said contoured surface at said predetermined location; and
disposing a thermally insulating topcoat over said surface feature, forming segmented portions that are separated by faults extending through the thermally insulating topcoat from said surface feature.

7. The method of claim 6 further comprising:
forming a pattern of features on said at least one contoured surface.

8. The method of claim 6 wherein said assembly of ligaments conforms to said contoured surface.

9. The method of claim 6 wherein said surface feature comprises a sharp edge proximate a top and a bottom of said surface feature.

10. The method of claim 6 further comprising:
disposing a bond coat layer to the at least one contoured surface, before disposing said thermally insulating topcoat.

11. The method of claim 6 wherein said gas turbine engine component is at least one of an airfoil, a seal, a bulkhead, a fuel nozzle guide, a transition duct and a combustor casing.

12. A method of locating a surface feature for geometrically segmented coatings on a gas turbine engine component having contoured surfaces comprising:
providing said gas turbine engine component having at least one contoured surface;
overlaying an assembly of ligaments on said contoured surface;
identifying a location for a surface feature on at least one of a geometric center of said assembly of ligaments and an intersection of said assembly of ligaments, a center of said ligaments, an end of said ligaments, and a combination of center and end of said ligaments;
forming said surface feature in said contoured surface at said location; and
disposing a thermally insulating topcoat over said surface feature, forming segmented portions that are separated by faults extending through the thermally insulating topcoat from said surface feature.

13. The method of claim 12 wherein said surface feature comprises at least one of a triangular shape, a circular shape, a hexagonal shape, and a polygonal shape.

14. The method of claim 13, wherein an edge of said features comprise at least one of sharp corners and rounded corners.

15. The method of claim 13 further comprising:
forming said surface feature from at least one of, milling, laser engraving, casting, chemical etching and additive manufacturing.

16. The method of claim 12 further comprising:
disposing a bond coat layer to the at least one contoured surface, before disposing said thermally insulating topcoat.

17. The method of claim 12 wherein said gas turbine engine component is at least one of an airfoil, a seal, a bulkhead, a fuel nozzle guide, a transition duct and a combustor casing.

18. The method of claim 12 wherein said assembly of ligaments is selected from the group consisting of a triangular assembly, a hexagonal assembly and a polygonal assembly.
